(19) United States
(12) Patent Application Publication
(10) Pub. No.: US 2004/0192107 A1
(43) Pub. Date: Sep. 30, 2004

(54) Coaxial connector

(76) Inventor: Kazuhiko Ikeda, Tokyo (JP)

Correspondence Address: KANESAKA & TAKEUCHI, 1423 Powhatan Street, Alexandria, VA, 22314, US

(21) Appl. No.: 10/812,896

(22) Filed: Mar. 31, 2004

(30) Foreign Application Priority Data
Mar. 31, 2003 (JP) 2003-094443

(51) Int. Cl. H01R 9/05

(52) U.S. Cl. 439/582

(57) ABSTRACT

A coaxial connector (51) comprises a terminal (54) having a first end side connected to a mating connector (52) and a second end side connected to a central conductor (58) of a coaxial cable (53), an insulating member (55) provided outside the terminal and holding the terminal, and an outer conductor (56) provided outside the insulating member, wherein the terminal is held between a terminal (81) of the mating connector or holds the terminal of the mating connector such that a connection angle between the terminals of the coaxial connector and mating connector is made an obtuse angle.

### BACKGROUND OF THE INVENTION

1. Field of the Invention

The present invention relates to a coaxial connector, especially a high frequency coaxial connector.

2. Description of the Related Art

This kind of coaxial connector is, for example, shown in FIGS. 16-19. As disclosed in Japanese Patent Application Kokai Number 2001-43939, this connector 1 comprises a terminal 2, an insulating member 3, and an outer conductor 4.

In FIG. 16, a plurality of the terminals 2 are provided at a belt-like metal carrier 5 at a predetermined interval. Each of the terminals 2 comprises a wiring portion 7 having a flat surface 6 and a pair of connection tongues 8 bent perpendicularly in a downward direction from sides of the wiring portion 7. The respective terminals are cut off from the metal carrier 5 at cut-off portions 9.

The insulating member 3 is made by molding an insulating material and comprises a substantially cylindrical body 10, a shoulder 11 extending from the upper portion of the body 10 to a basement side, and a middle cover 12 extending upwardly from the upper portion of the body 10 on the opposite side of the shoulder 11. An opening 13 extending through the body 10 vertically is provided for accommodating the connection tongues 8 and placement surfaces 14 are provided at sides of the opening 13.

The outer conductor 4 is made by processing a metal sheet and comprises a tubular portion 15 for receiving the body 10 of the insulating member 3, a side box 16 provided on the basement side of the tubular portion 15 for surrounding the shoulder 11, and an outer cover 17 extending upwardly from the tubular portion 15 on the opposite side of the side box 16. An engagement projection 18 having a sectional shape of a semicircle projecting inwardly is provided at the lower end of the tubular portion 15. The outer cover 17 has a base 19, a body cover 20, a shoulder cover 21, and a cable grip 22. A pair of clips 23 bent at right angles are provided at sides of the body cover 20.

For assembling this coaxial connector 1, an central conductor 25 of a coaxial cable 24 is connected to the connector 1 at the wiring portion 7 by soldering and the terminal 2 is cut off from the carrier 5 at the cut-off portion 9. The terminal 2 is accommodated in the opening 13 of the insulating member 3 such that sides 26 of the wiring portion 7 are placed on the placement surface 14 and the coaxial cable 24 is placed on the shoulder 11. Then, the body 10 is plugged in the tubular portion 15 and the shoulder 11 is plugged in the side box 16. The outer cover 17 of the outer conductor 4 is bent at the base 19 to the basement side. The middle cover 12 of the insulating member 3 is pushed by and bent with the outer cover 17 so that the shoulder cover 21 and the cable grip 22 grips the shoulder 11 and the coaxial cable 24, respectively, thus the outer conductor 4 is fixed to the insulating member 3.

In FIG. 17, a mating connector 27 comprises a terminal 28, a flat insulating member 29 and a cylindrical outer conductor 30 provided on the insulating member 29. The terminal 28 has a base 31 provided along the insulating member 29 and a reverse U-shaped connection portion 32 bent and projecting perpendicularly in an upward direction from the base 31. An engagement groove 33 is provided at the lower portion of the outer conductor 30 to engage the engagement projection 18.

As shown in FIG. 18, for connecting the connector 1 to the mating connector 27, the tubular portion 15 of the connector 1 is plugged in the outer conductor 30 of the mating connector 27. The connection portion 32 of the mating connector 27 is held between the connection portions 8 of the connector 1 and the engagement projection engages the engagement groove 33. Consequently, the plugging condition between the connectors 1 and 27 is locked and the electrical connection between the connectors 1 and 27 is secured.

For removing the connector 1 from the mating connector 27, the connector 1 is pulled upwardly at the clips 23. The engagement projection 18 is disengaged from the engagement groove 33, thus the connector 1 is removed from the mating connector 27.

In the above conventional connector, however, the connection portions 8 and 32 are made perpendicular with respect to the wiring portion 7 and the base 31, respectively, so that as shown in FIG. 18, a transmission line 34 has two right-angled portions 35 and 36. Accordingly, the high-frequency characteristics are disturbed at the right-angled portions 35 and 36 and it is difficult to adjust the high-frequency transmission characteristics. Also, it is difficult to make a connector with a low profile and a small size because of the presence of the two right-angled portions in a heightwise direction of the connector.

Since the cable grip 22 for fixing the coaxial cable 24 is provided far on the basement side from the engagement projection and groove 18 and 33 for locking the plugging condition of the connectors 1 and 27, the connector is lengthy in the longitudinal direction of the connector. Also, since the clips 23 for removing the connector 1 are positioned above the tubular portion 15, the connector is large in widthwise and heightwise directions. Consequently, it is difficult to make a small-sized connector having a sufficient effective plugging area.

Moreover, as shown in FIG. 19, if it is attempted that the connector 1 is removed by lifting up the cable grip 22 without using the clips 23, the connection portion 32 may damage a top portion 37 of the insulating member 3.

### SUMMARY OF THE INVENTION

Accordingly, it is an object of the invention to provide a small-sized coaxial connector having the superior high-frequency characteristics.

According to an aspect of the invention, a coaxial connector comprises a terminal having a first end side connected to a mating connector and a second end side connected to a central conductor of a coaxial cable, an insulating member provided outside the terminal and holding the terminal, and an outer conductor provided outside the insulating member, wherein the terminal is held between a terminal of the mating connector or holds the terminal of the mating connector such that a connection angle between the terminals of the coaxial connector and mating connector is made an obtuse angle.

The terminal may have a slanted portion on the first end side.

An aperture is provided in front of the first end side of the terminal.

The outer conductor has an engagement portion for engaging a connection condition with the mating connector and a fixed portion for fixing the coaxial cable, wherein the engagement and fixed portions are disposed at positions overlapped with each other in a longitudinal direction of the coaxial connector.

According to another aspect of the invention, a coaxial connector comprises a terminal projecting into a plugging area to be plugged with a mating connector, wherein the terminal is held between terminal of the mating connector or holds the terminal of the mating connector such that a connection angle between the terminals of the coaxial connector and mating connector is made an obtuse angle.

The terminal may have a slanted portion on a basement side thereof.

According to still another aspect of the invention, first and second coaxial connectors are plugged with each other. The first coaxial connector comprises a first terminal having a first end side connected to the second coaxial connector and a second end side connected to a central conductor of a coaxial cable, an insulating member provided outside the first terminal and holding the first terminal, and an outer conductor provided outside the insulating member, and a second coaxial connector comprises a second terminal projecting into a plugging area to be plugged with the first coaxial connector, wherein the first terminals is held between the second terminal or the second terminal is held between the first terminal such that a connection angle between the first and second terminals is made an obtuse angle.

According to yet another aspect of the invention, a terminal having a wiring portion connected to a central conductor of a coaxial cable and a connection portion connected to a mating connector, an insulating member provided outside the terminal and having a terminal holding portion for holding the terminal, and an outer conductor provided the insulating member, wherein the wiring portion and the terminal holding portion have shapes of a dovetail groove opened to a bottom side such that the wiring portion is plugged into the terminal holding portion.

Since the connection angle between the terminals is made an obtuse angle, it is possible to minimize the heightwise dimension of the connectors. The engagement section for locking the plugging condition between connectors and the fixing section for fixing the coaxial cable are provided at overlapped positions, it is possible to reduce the dimension in the longitudinal direction. In addition, since the connector is removed simply by lifting the cable holding tabs without using the conventional clips provided above the plugging section, it is possible to reduce the dimensions in the widthwise and heightwise directions too. Consequently, the connector is made small-sized with a low profile.

### BRIEF DESCRIPTION OF THE DRAWINGS

FIG. 1 is a perspective view showing a coaxial connector before assembling according to an embodiment of the present invention

FIG. 2 is a perspective view showing the coaxial connector of FIG. 1 after assembling.

FIG. 3 is an exploded perspective view showing the embodiment of the present invention.

FIG. 4 is a bottom view showing the embodiment of the present invention.

FIG. 5 is a sectional view taken along the line A-A in FIG. 4.

FIG. 6 is a sectional view taken along the line B-B in FIG. 4.

FIG. 7 is a sectional view taken along the line C-C in FIG. 4.

FIGS. 8(a)-8(c) are sectional views of a wiring portion of a terminal according to the embodiment of the present invention.

FIG. 9 is a perspective view showing the embodiment of the present invention.

FIG. 10 is an exploded perspective view showing the embodiment of the present invention.

FIGS. 11-13 are sectional views showing the embodiment of the present invention.

FIG. 14 is a side view of a terminal according to another embodiment of the present invention.

FIG. 15 is a side view of a terminal according to still another embodiment of the present invention.

FIG. 16 is an exploded perspective view of a coaxial connector according to the prior art.

FIGS. 17-19 are sectional views showing the prior art.

### DESCRIPTION OF THE PREFERRED EMBODIMENTS

The embodiments of the present invention will now be described with reference to the accompanying drawings.

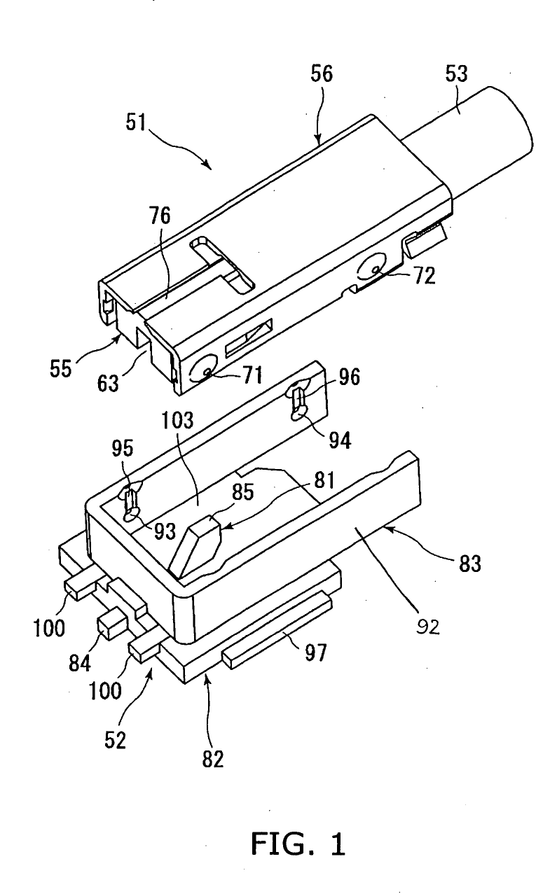

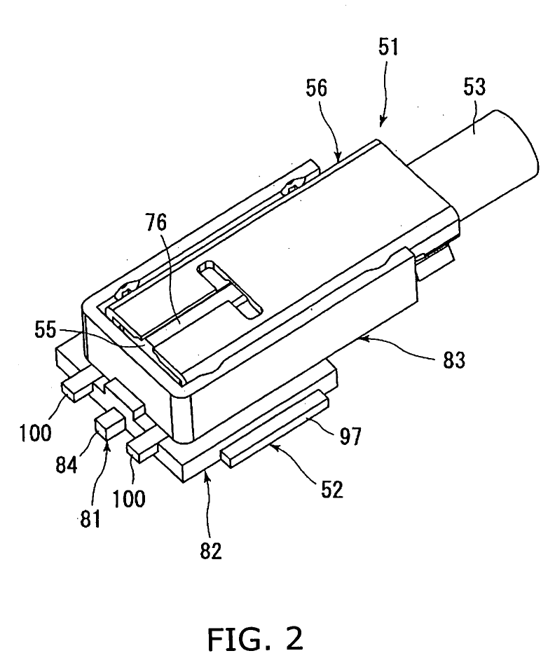

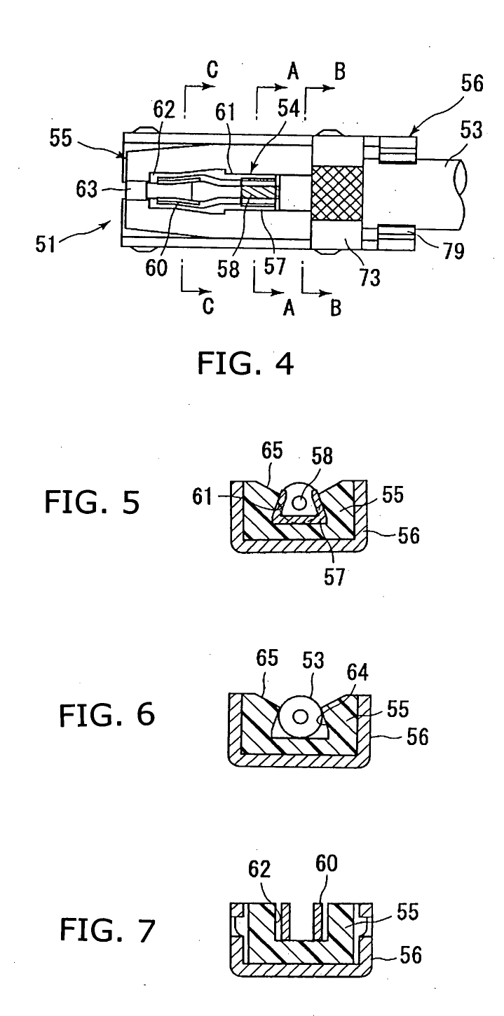

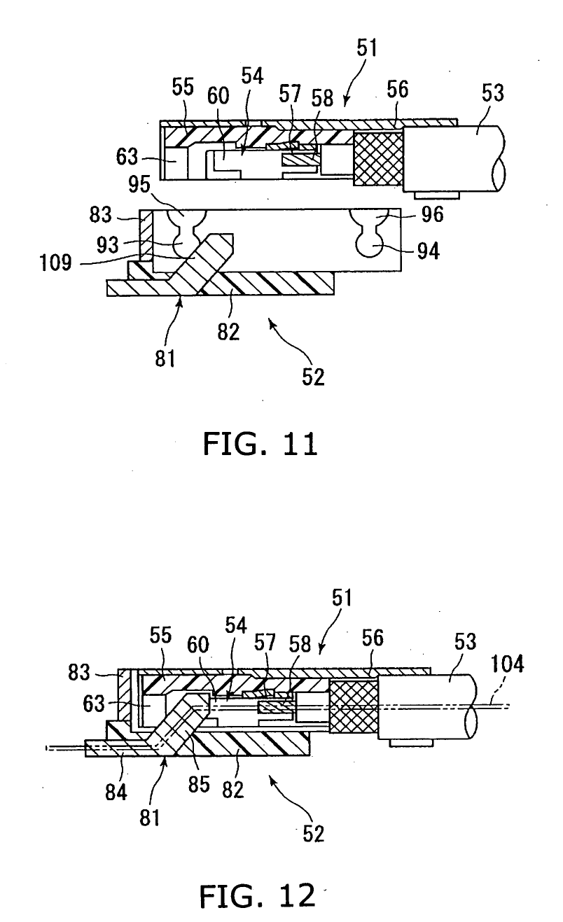

FIGS. 1-13 show a coaxial connector according to the present invention, wherein a connector 51 is plugged in a mating connector 52 for electrical connection.

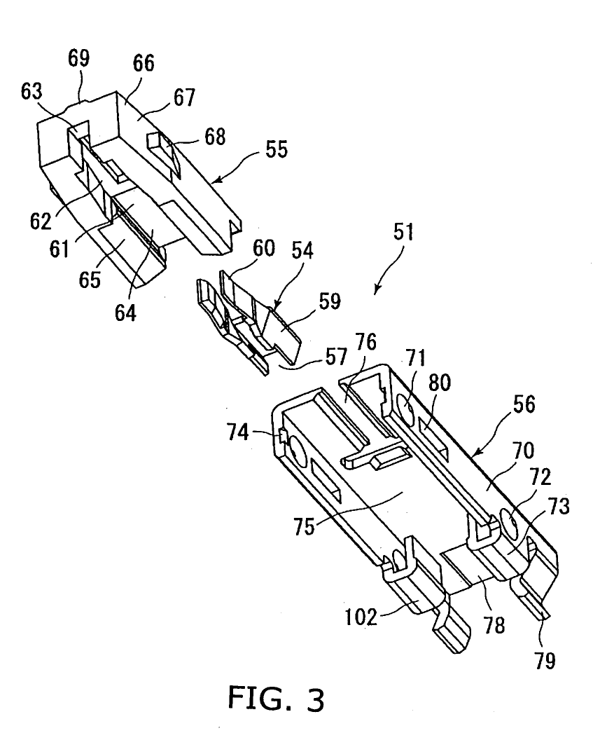

As best shown in FIG. 3, the connector 51 comprises a terminal 54 connected to the top end of a coaxial cable 53 (refer to FIG. 9), an insulating member 55 provided outside the terminal 54, and an outer conductor 56 provided outside the insulating member 55. As shown in FIG. 5, a wiring portion 57 having a shape of a dovetail groove opened to the bottom side is provided on the basement side of the terminal 54 so that a central conductor 58 of the coaxial cable 53 is connected to the wiring portion 57. Here, the shape of the dovetail groove is not limited to a triangular shape as shown in FIG. 5 but includes every shapes, such as a rectangular and a circle, which are narrow on the bottom side to prevent the coming-off of the coaxial cable 53 from the bottom side. A pair of connection portions 60 are provided at the top of the terminal. The connection portions 60 extend from left and right side walls of the wiring portion 57 in a top end direction so as to hold a connection portion 85 of a terminal 81 of the mating connector 52 therebetween.

As shown in FIGS. 5 and 7, a terminal holding portion 61 having a shape of a dovetail groove opened to the bottom side is provided in the center of the insulating member 55, and a rectangular groove 62 is provided at the top of the terminal holding portion 61. When the wiring portion 57 is plugged in the terminal holding portion 61, the connection portion 60 is plugged in the rectangular groove 62. An aperture 63 is provided on the top side of the rectangular groove 62 and a cable holding portion 64 having a shape of a dovetail groove is provided on the basement side of the terminal holding portion 61. As shown in FIG. 6, the cable holding portion 64 has the same sectional shape as that of the terminal holding portion 61. A guide portion 65 is provided on the bottom side of the insulating member 55, which is inclined toward the terminal and cable holding portions 61 and 64. Top portions 66 with outside inclined surfaces 67 gradually tapered toward the top are provided at the respective side walls of the insulating member 55. A projection 68, which is tapered on the basement side, is provided in the center of each of the side walls of the insulating member 55. A raised portion 69 having tapers on sides thereof is provided in the longitudinal direction in the upper surface of the insulating member 55 in the center of the top side.

The outer conductor 56 is made by bending a metal sheet in a “C” form such that it covers the upper surface and the side walls of the insulating member 55. Engagement projections 71 and 72 are provided at on the top and basement sides of left and right side walls 70 of the outer conductor 56, respectively, to lock the connection condition with the mating connector 52. Cable grip portions 73 are provided in the respective side walls 70 such that they are folded from the engagement projections 72 on the basement side toward the inside of the outside conductor 56. Thus, since the cable grip portions 73 are disposed at positions in the longitudinal direction of the outer conductor 56 corresponding to the engagement projections 72on the basement side, the dimension of the outer conductor 56 in a lengthwise direction can be made small. Engagement windows 80 are provided on the basement side of the engagement projections 71 on the top side to engage the engagement projections 68. A chamfer 74 is provided at the inside of the top portion of each of the side walls 70. A T-shaped cut-off portion 76 is provided in the upper surface 75 of the outer conductor 56 in the center on the top side such that the raised portion 69 of the insulating member 55 fits in the cut-off portion 76. A dent 78 is provided in the inside of the upper surface 75 so that the coaxial cable 53 does not interfere with the basement portion of the outer conductor 56. In this embodiment, a pair of cable holding tabs 79, of which lower parts are widen, are provided on the basement side of the cable grip portion 73 although they are not always necessary.

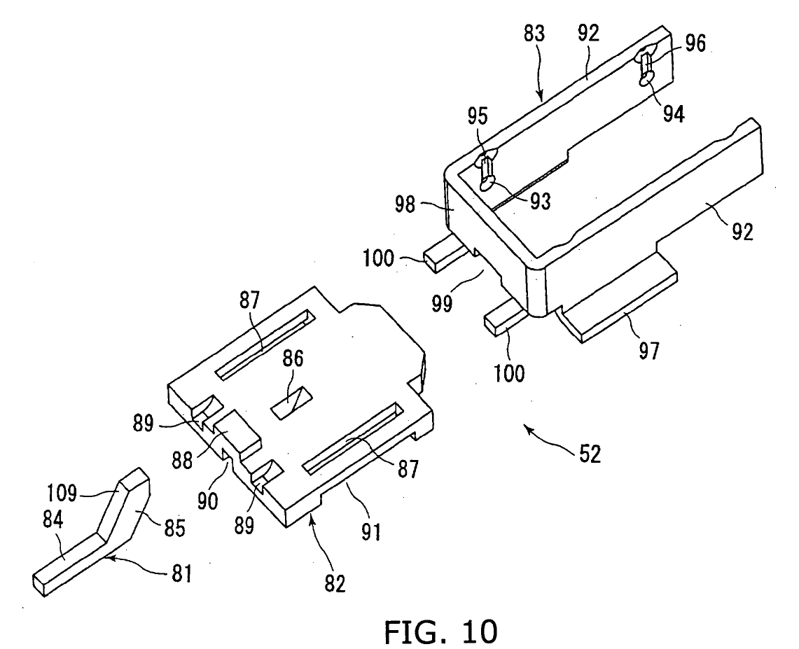

As best shown in FIG. 10, the mating connector 52 comprises a terminal 81, an insulating member 82 to hold the terminal 81, and outer conductor 83 integrally formed with the insulating member 82. A bar-like base portion 84 is provided at the top side of the terminal 81 and connected to a predetermined circuit traces of a circuit board (not shown). A plate-like connection portion 85 is provided on the basement side of the terminal 81, which extends obliquely such that the internal angle between the connection portion 85 and the base portion 84 becomes an obtuse angle to have a slant portion 109.

The insulating member 82 is a rectangular plate with part on the basement side thereof extends in the basement direction. A terminal hole 86 is provided in the center of the insulating member 82 into which the connection portion 85 is inserted, and slits 87 are provided at sides of the terminal hole 86. A positioning projection 88 is provided in the center of the top portion of the insulating member 82 and positioning ditches 89 are provided at sides of the positioning projection 88. A terminal groove 90 extending from the central top to the terminal hole 86 is provided on the bottom side of the insulating member 82 extending into which the base portion 84 is inserted, and broadened grooves 91 extending from the left and right edges of the insulating member 82 to the respective silts 87 are provided.

The outer conductor 83 is made by bending a metal sheet in a “C” form. Engagement cavities 93 and 94 are provided in the insides of left and right side walls 92 on the top and basement sides, respectively. Guide ditches 95 and 96 extend from the respective engagement cavities 93 and 94 to the upper edges of the side walls 92 and the upper portions of the guide ditches 95 and 96 are broadened. The left and right side walls 92 on the top side are bent to provide supporting portions 97 which extend horizontally from the lower edge to the outside. The supporting portions 97 fit in the slits 87. A cut-off portion 99 is provided in the central lower edge of the a top wall 98 of the outer conductor 83 to engage the positioning projection 88. Extended portions 100 are provided at sides of the cut-off portion 99, which extend from the lower edge in a top side direction to engage the positioning ditches 89.

For assembling the connector 51, as shown in FIG. 3, the terminal 54 is inserted into the cable holding portion 64 from the basement side of the insulating member 55 so that the wiring portion 57 is plugged in the terminal holding portion 61. Since both the wiring portion 57 and the terminal holding portion 61 have the shape of dovetail opened to the bottom side, the wiring portion 57 is firmly held by the terminal holding portion 61. Accordingly, the terminal 54 does not come off from the insulating member 55 even when downward force is applied to the terminal 54 upon removing the connector 51. At this point, the connection portions 60 are plugged into the rectangular groove 62 such that they are resiliently deformed in a left-and-right direction.

Then, the insulating member 55 with the terminal 54 is inserted into the outer conductor 56 from the top side of the outer conductor 56. The projections 68 abut against the chamfers 74 so that the outer conductor 56 is resiliently deformed in a left-and-right direction. When the insulating member 55 is further pushed into the outer conductor 56, the projections 68 engage the engagement windows 80 and the outer conductor 56 returns to the original condition, thus fixing the insulating member 55 in the outer conductor 56. When the raised portion 69 is plugged in the cut-off portion 76, since the top portion 66 has the tapered shape, there is provided a gap at the inside of the top portion of the outer conductor 56, which enables the top portion of the outer conductor 56 to resiliently deform in the left-and-right direction. At this point, the cable grip portions 73 positioned on the basement side of the insulating member 55 prevents the insulating member 55 from being pushed excessively into the outer conductor 56. Accordingly, the outer conductor 56 is firmly held at a predetermined position of the insulating member 55. Since the projections 68 have tapers on the basement side, the outer conductor 56 is inserted into the insulating member 55 smoothly.

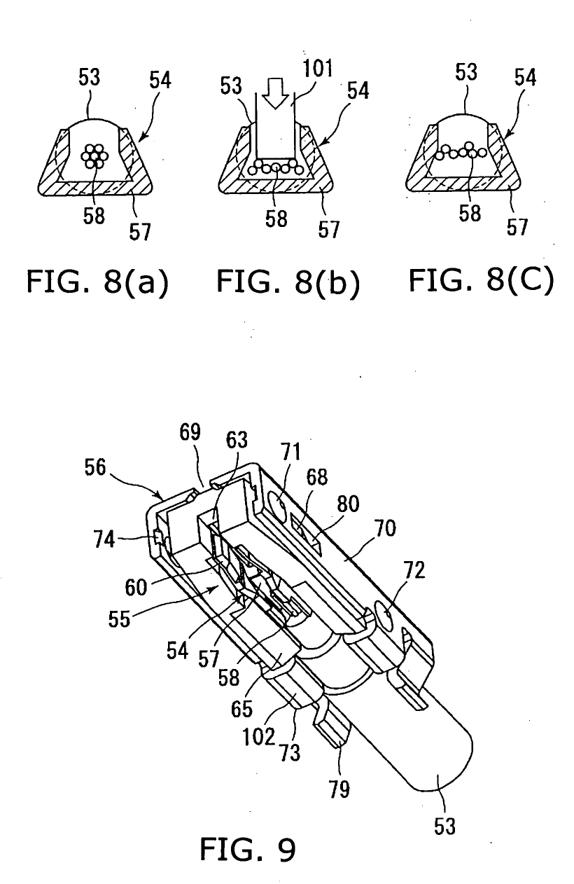

Then, as shown in FIG. 8, the central conductors 58 of the coaxial cable 53 are inserted into the wiring portion 57 and widespread by a jig 101 so as to prevent of coming off of the central conductors 58 from the wiring portion 57. Finally, the coaxial cable 53 fits in the cable holding portion 64, cable grip portion 73, and cable holding tabs 79. At this point, since the guide portion 65 is provided in the cable holding portion 64, a folded portion 102 is curved from the lower end of the cable grip portion 73, and the lower portion of the cable holding tabs 79 is widened outwardly, the coaxial cable 53 fits in these elements smoothly. Since all the terminal 55, insulating member 55, and outer conductor 56 are opened to the bottom side thereof, the connector 512 can be assembled on the bottom side. Also, the soldering of the central conductor to the wiring portion 57 and the soldering of an outer conductor of the coaxial cable to the cable grip portion 73 are performed on the bottom side. Accordingly, the assembly work is simplified, enabling a small connector to be assembled easily. Also, the manufacturing cost is reduced. Moreover, since the cable grip portion 73 is folded apart from the outer conductor 56, when the outer conductor of the coaxial cable 53 is soldered to the cable grip portion 73, a soldering material and flux are not adhered to the outer conductor 56, thus simplifying the assembling work and increasing the reliability of the connector 51.

The insulating member 82 of the mating connector 52 is molded integrally with the terminal 81 and the outer conductor 83 after positioning the terminal 81 and the outer conductor 83 at predetermined positions. Consequently, the terminal 81 is held by the insulating member 82 with the connection portion 85 inserted into the terminal hole 86 and the base 84 plugged in the terminal groove 90. Also, the outer conductor 83 is fixed to the insulating member 82 with the cut-off portion 99 and the extended portions 100 being engaged with the positioning projection 88 and the positioning ditches 89, respectively, and with the supporting portions 97 being plugged in the slits 87. Consequently, a plugging cavity 103 (FIG. 1) defined by the insulating member 82 and the outer conductor 83 is provided in the mating connector 52 for plugging with the connector 51 and the connection portion 85 of the terminal 81 keeps the slanted posture projecting toward the basement side in the plugging cavity 103. As shown in FIG. 1, the top side of the side walls 92 of the outer conductor 83 are fixed to the insulating member but the basement side projects from the insulating member 82 toward the basement side so as to be resiliently deformed in a widthwise direction of the mating connector 52.

The engagement and disengagement operations between the connector 51 and the mating connector 52 will be described with respect to mainly FIGS. 1, 2, and 11-13.

When plugging the connector 51 into the mating connector 52, the mating connector 52 is, firstly, disposed on a predetermined position of a circuit board (not shown) and the base 84 of the terminal 81 is connected to a predetermined circuit trace of the circuit board. Then, the engagement projections 71 and 72 are positioned to the engagement cavities 93 and 94, respectively, to plug the connector 51 into the plugging cavity 103. Since the top side portion of the outer conductor 56 of the connector 51 and the basement side of the outer conductor 83 of the mating connector 52 are made resiliently deformed in the widthwise direction, and also the guide grooves 95 and 96 are provided in the outer conductor 83 of the mating connector 52, the positioning work between the connectors 51 and 52 during the plugging operation can be done easily and smoothly. Since the engagement projections 71 and 72 and the engagement cavities 93 and 94 are provided in the flat plate of the side walls 70 and 92 of the outer conductors 56 and 83, respectively, the positions of these elements are determined precisely, resulting in the precise engagement operation between the engagement projections 71 and 71 and engagement cavities 93 and 94. In addition, the engagement position between the engagement projection and cavity 71 and 93 is arranged on the top side and that between the engagement projection 72 and cavity 94 is arranged on the basement side which receives external force from the coaxial cable 53 so that the plugging condition between the connectors 51 and 52 is firmly locked.

In the plugging condition, as shown in FIG. 12, the connector portion 85 of the terminal 81 of the mating connector 52 is held between the connection portions 60 of the terminal 54 of the connector 51 and the connection angle between the terminals 54 and 81 is made an obtuse angle. Accordingly, since the right-angled portion, which causes the disturbance of the high-frequency characteristics, is not provided in the transmission line 104, the adjustment of the high-frequency transmission characteristics is improved. Consequently, the dimension in a heightwise direction is made small with the effective plugging area between the terminals maintained so that it is possible to make the connectors small-sized with a low profile.

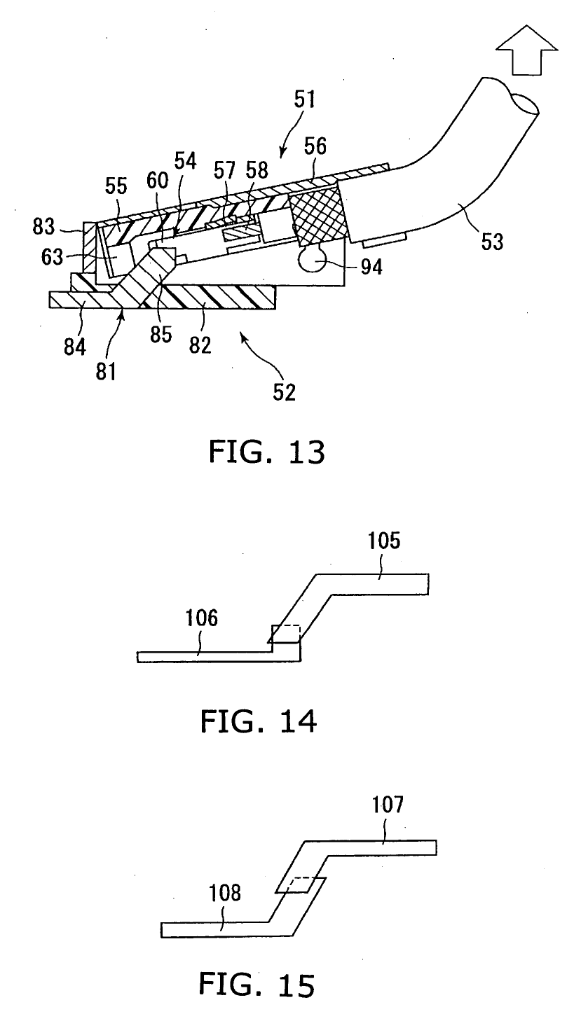

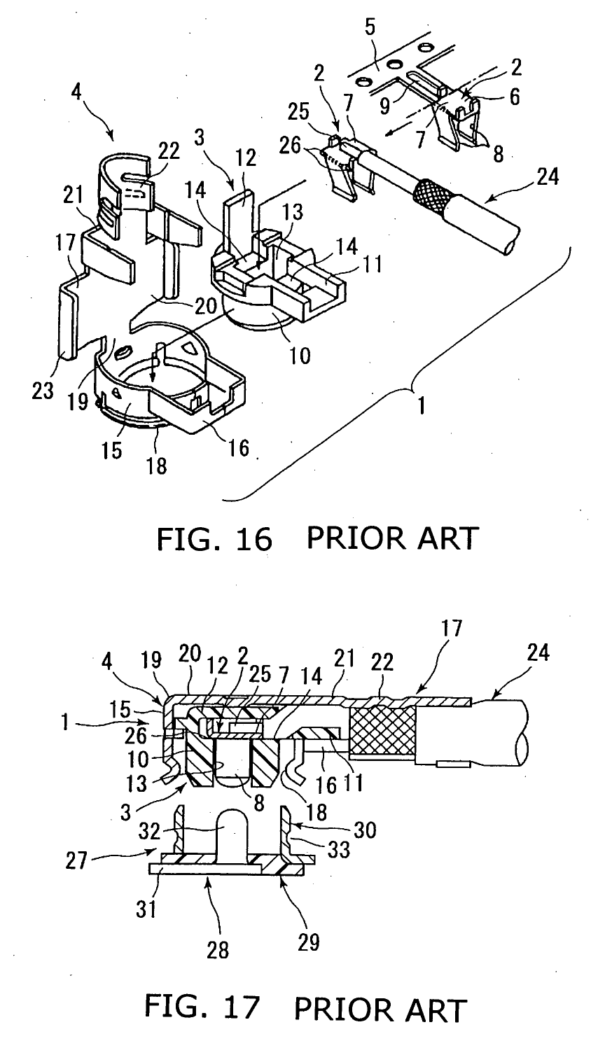

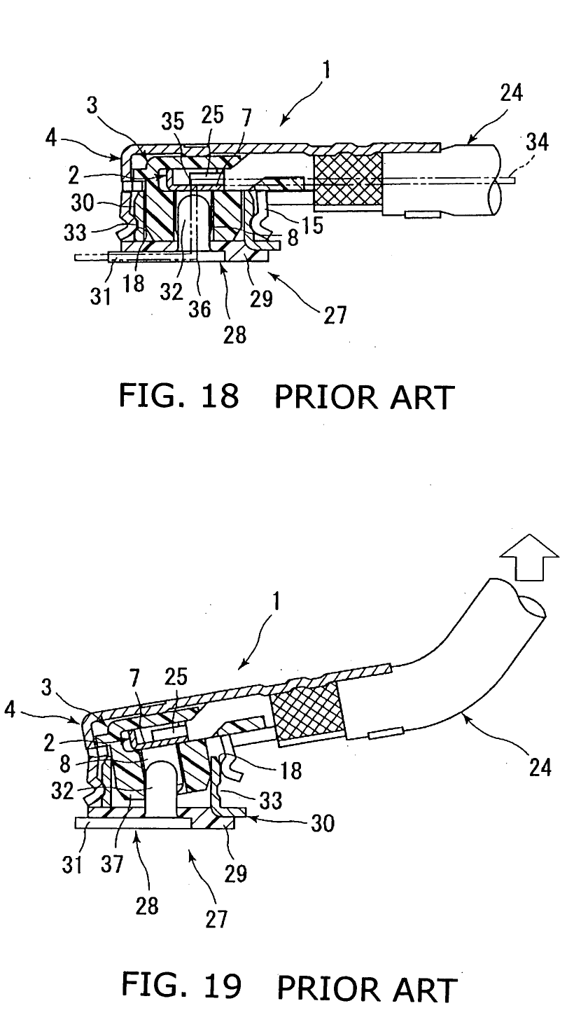

When removing the connector 51 from the mating connector 52, as shown in FIG. 13, the cable holding tabs 79 are lifted up so that the basement side portion of the outer conductor 83 of the mating connector 52 is resiliently deformed outwardly and the engagement projection and cavity 72 and 94 on the basement side are disengaged. When the cable holding tabs 79 are further lifted up, the connection portions 60 and 85, and the engagement projection and cavity 71 and 94 on the top side are disengaged, respectively, thus the connector 51 is removed from the mating connector 52. Since the aperture 63 is provided in front of the connection portion 60 of the connector 51, the connection portion 85 of the mating connector 52 does not interfere with the insulating member 55, thus preventing the insulating member 55 from receiving damage. As stated above, the connector 51 can be removed from the mating connector 52 only by lifting the cable holding tabs 79 so that the operation is simplified. In addition, the slanted portion 109 is provided in the connection portion 85 of the terminal 81 of the mating connector 52, even when the connector 51 is removed in an oblique direction, it is hard for the connection portion 85 to interfere with the insulating member 55. Accordingly, the area of the aperture 63 is minimized.

The shapes of the terminals 54 and 81 of the connectors 51 and 52 are not limited to the above description. For example, in FIG. 14, the top side portion of a terminal 105 of the connector 51 is slanted downwardly and a terminal 106 of the mating connector 52 is bent upwardly at a right angle. Alternatively, in FIG. 15, both terminals 107 and 108 are slanted at an obtuse angle. Although not shown, the upper surface on the top side of the connector 60 of the connector 51 may be cut off to provide a slanted portion. The terminals 54 and 81 of the connectors 51 and 52 may be made curved instead of straight. In addition, such a structure is acceptable that the terminals 81 of the mating connectors 52 hold the terminal 54 of the connector 51 therebetween instead of being held between the terminals 54. In the above embodiments, the plugging cavity 103 is provided in the mating connector 52. However, it is possible to provide a plugging cavity in the connector 51. In this case, the terminal 54 is provided in the plugging cavity and the insulating member of the connector should be made similar to the insulating member 82 of the mating connector 52 to create a space for the plugging cavity within the outer conductor 56. On the contrary, it is desirable that the insulating member of the mating connector 51n should be made similar to the insulating member 55 of the connector 51 to support the terminal of the mating connector 51.

The shape of the cable grip 22 is not limited to the above description. Many variations are possible if the coaxial cable 24 is fixed to the outer conductor 4.

As fully described above, since the connection angle between the terminals is made an obtuse angle, it is possible to minimize the heightwise dimension of the connectors. The engagement section for locking the plugging condition between connectors and the fixing section for fixing the coaxial cable are provided at overlapped positions, it is possible to reduce the dimension in the longitudinal direction. In addition, since the connector is removed simply by lifting the cable holding tabs without using the conventional clips provided above the plugging section, it is possible to reduce the dimensions in the widthwise and heightwise directions too. Consequently, the connector is made small-sized with a low profile.

1. A coaxial connector comprising:
a terminal having a first end side connected to a mating connector and a second end side connected to a central conductor of a coaxial cable;
an insulating member provided outside said terminal and holding said terminal; and
an outer conductor provided outside said insulating member, wherein said terminal is held between a terminal of said mating connector or holds said terminal of said mating connector such that a connection angle between said terminals of said coaxial connector and mating connector is made an obtuse angle.

2. The coaxial connector according to claim 1, wherein said terminal has a slanted portion on said first end side.

3. The coaxial connector according to claim 1, wherein an aperture is provided in front of said first end side of said terminal.

4. The coaxial connector according to claim 1, wherein said outer conductor has an engagement portion for engaging a connection condition with said mating connector and a fixed portion for fixing said coaxial cable, said engagement and fixed portions being disposed at positions overlapped with each other in a longitudinal direction of said coaxial connector.

5. A coaxial connector comprising a terminal projecting into a plugging area in which a mating connector is plugged with said coaxial connector, wherein said terminal is held between a terminal of said mating connector or holds said terminal of said mating connector such that a connection angle between said terminals of said coaxial connector and mating connector is made an obtuse angle.

6. The coaxial connector according to claim 5, wherein said terminal has a slanted portion on a basement side thereof.

7. A coaxial connector assembly composed of first and second coaxial connectors plugged with each other, said first coaxial connector comprising:
a first terminal having a first end side connected to said second coaxial connector and a second end side connected to a central conductor of a coaxial cable;
an insulating member provided outside said first terminal and holding said first terminal; and
an outer conductor provided outside said insulating member, said second coaxial connector comprising:
a second terminal projecting into a plugging area in which said first connector is plugged with said first coaxial connector, wherein said first terminal is held between said second terminal or said second terminal is held between said first terminal such that a connection angle between said first and second terminals is made an obtuse angle.

8. A coaxial connector comprising:
a terminal having a wiring portion connected to a central conductor of a coaxial cable and a connection portion connected to a mating connector;
an insulating member provided outside said terminal and having a terminal holding portion for holding said terminal; and
an outer conductor provided said insulating member, wherein said wiring portion and said terminal holding portion have shapes of a dovetail groove opened to a bottom side such that said wiring portion is plugged into said terminal holding portion.

9. A coaxial connector assembly composed of first and second coaxial connectors plugged with each other, said first coaxial connector comprising:
a first terminal provided in a plugging area in which said second coaxial connector is plugged with said first coaxial connector, and having a first end side connected to said second coaxial connector and a second end side connected to a central conductor of a coaxial cable, said second coaxial connector comprising:
a second terminal connected to said first coaxial connector;
an insulating member provided outside said second terminal and holding said second terminal; and
an outer conductor provided outside said insulating member, wherein said first terminal is held between said second terminal or said second terminal is held between said first terminal such that a connection angle between said first and second terminals is made an obtuse angle.
